(19) United States
(12) Patent Application Publication
(10) Pub. No.: US 2008/0003545 A1
(43) Pub. Date: Jan. 3, 2008

(54) Apparatus for interacting with a storyboard and for making rubbings

(75) Inventors: Cynthia S. Mark-Hummel, Bolingbrook, IL (US); Peter James Crabbe, Aurora, IL (US)

Correspondence Address: GREENBERG TRAURIG, LLP, 77 WEST WACKER DRIVE, SUITE 2500, CHICAGO, IL, 60601-1732, US

(73) Assignee: DuPage Children's Museum, Naperville, IL (US)

(21) Appl. No.: 11/809,605

(22) Filed: Jun. 1, 2007

Related U.S. Application Data
(60) Provisional application No. 60/818,125, filed on Jun. 30, 2006.

(51) Int. Cl. G09B 11/00; A63H 33/00

(52) U.S. Cl. 434/85

(57) ABSTRACT

An apparatus which carries a storyboard comprised of images and/or text and which allows a user to place and arrange on a rubbing board select ones of a plurality of rubbing objects that are related to the images and/or text depicted on the storyboard. The apparatus further provides for the user positioning a sheet of paper over the selected and arranged rubbing objects whereupon the user may move a marker, crayon, or the like back and forth across the paper and the underlying rubbing object to cause the image(s) carried by the rubbing object(s) to be imposed onto the paper.

### BACKGROUND

In the art systems for making rubbings are known. For example, U.S. Pat. No. 6,916,179 illustrates and describes a kit for creating printed images by transferring a bas relief pattern of a rubbing object onto a sheet of paper by a rubbing process. The kit includes markers, rubbing objects, a rubbing board having a work surface, and storage areas for the markers and rubbing objects.

Similarly, U.S. Pat. No. 4,445,868 illustrates and describes an apparatus capable of being used by a child for the production of rubbings which includes a housing which is divided into a first section and a second section hinged to the first section. At least two elements are located in the first section and each of the elements has a plurality of independent surfaces with raised relief indicia located on the surfaces. The elements are rotatably mounted in the first section so as to locate at any one time one of the surfaces on each of the elements in a working plane. Each of the surfaces so located in the working plane is capable of supporting material which is capable of receiving a rubbing. The second section is positionable on the first section in a holding position, so as to hold the material against the surfaces in the working plane during the production of the rubbing. The rubbing is produced by drawing a crayon or the like over the surface of the material to transfer the outline of the raised relief on to the material.

What is needed in the art, however, is an apparatus for interacting with stories as well as for making rubbings which, among other things, provides an improved means for both educating a user while developing or rehabilitating the motor skills of the user.

### SUMMARY

To address this and other needs, the following generally describes an apparatus which carries a storyboard comprised of images and/or text depicting, for example, a nursery rhyme, a fairly tale, etc., and which allows a user to place and arrange on a rubbing board select ones of a plurality of rubbing objects that are identical to or contextually related to the images and/or text depicted on the storyboard. The apparatus further provides for the user positioning a sheet of paper over the selected and arranged rubbing objects whereupon the user may move a marker, crayon, or the like back and forth across the paper and the underlying rubbing object to cause the image(s) carried by the rubbing object(s) to be imposed onto the paper.

A better understanding of the objects, advantages, features, properties and relationships of the subject invention will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the invention described hereinafter, reference may be had to preferred embodiments shown in the following drawings in which:

FIG. 1 is a perspective view of an apparatus for creating stories and for making rubbings;

FIG. 2 is a cross-sectional view of the apparatus illustrated in FIG. 1;

FIG. 3 is a top plan view of the apparatus illustrated in FIG. 1; and

FIG. 4 is an exploded parts view of the apparatus illustrated in FIG. 1.

### DETAILED DESCRIPTION

With reference to the figures, in which like numerals refer to like elements, the following generally describes an apparatus 10 for interacting with stories as well as for making rubbings. As will become apparent, the apparatus 10 is both an educational tool as well as a tool for developing or rehabilitating the motor skills of a user. For educational purposes, the apparatus 10 provides a means for the user to view objects, a story, or the like presented to the user using a storyboard 12 comprised of images and/or text while further providing a means for the user to attempt to recreate the order of the objects, story, etc. and/or create variations of the objects, story, etc. by placing and arranging on a rubbing surface 14 select ones of a plurality of rubbing objects 16 that are identical to or otherwise related to the images and/or text depicted on the storyboard 12. It will be understood that rubbing objects are objects having raised or recessed indicia formed thereon. Once the user selects and arranges the rubbing objects 16 on the rubbing surface 14 as desired, the apparatus further allows the user to position a sheet of paper or the like over the one or more of the rubbing objects 16 whereupon the user may move a marker, crayon, or the like back and forth across the paper and the underlying rubbing object(s) 16 to cause the image(s) carried by the rubbing object(s) 16 to be imposed onto the paper. The manipulation by the user of the apparatus 10 as well as the rubbing objects 16, the paper, and the crayon thus provides the means for developing or rehabilitating the motor skills of the user.

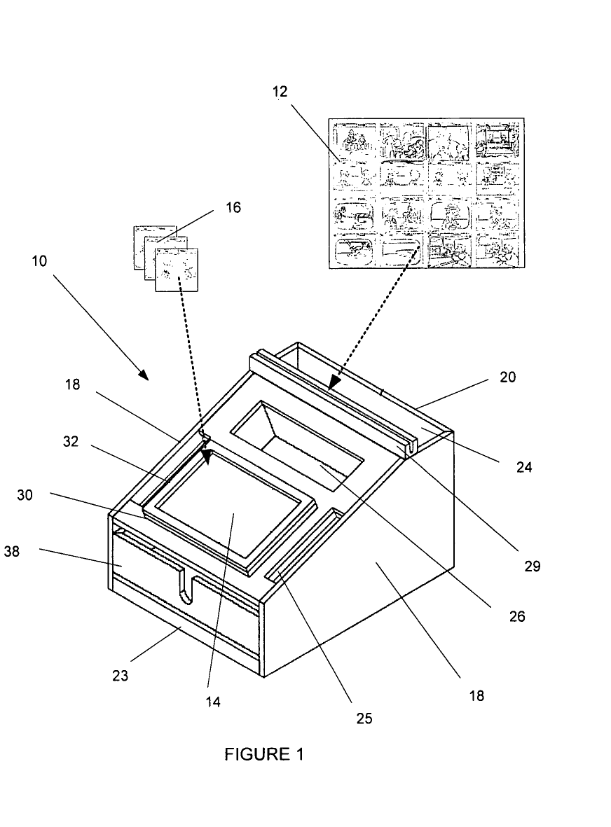

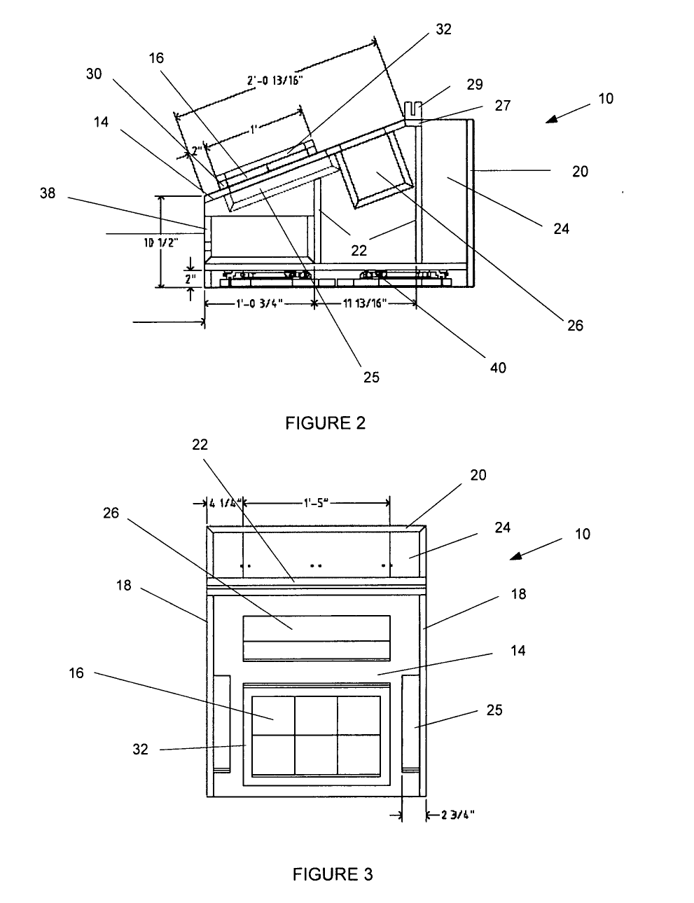

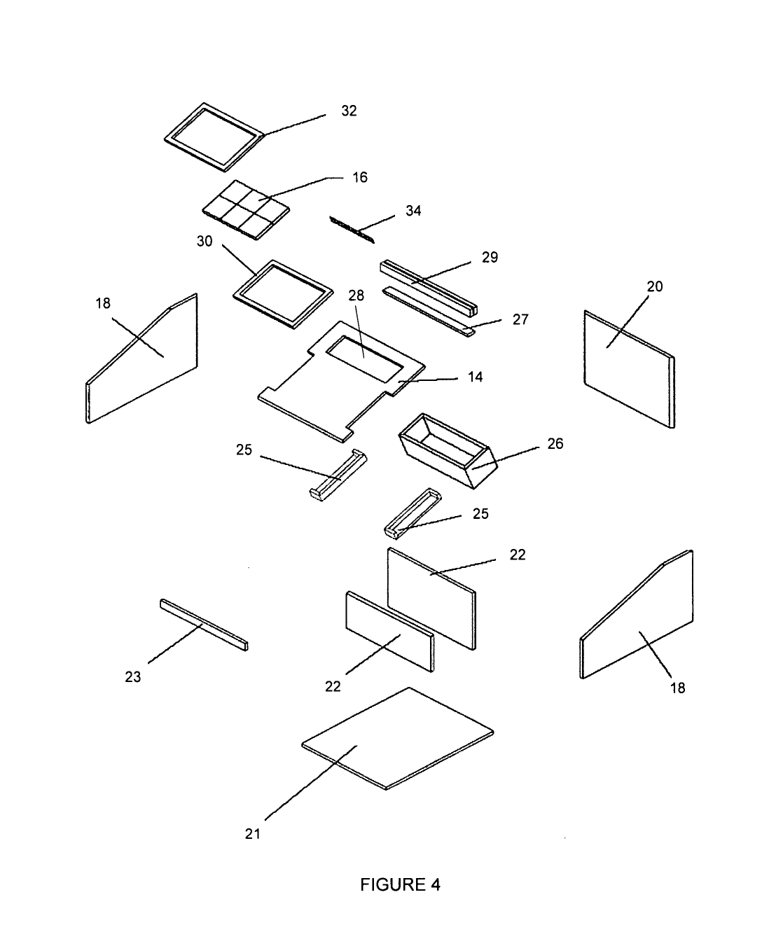

For carrying the storyboard 12, the rubbing objects 16, and additional materials that may be utilized in connection with the apparatus 10 as well as for allowing the apparatus 10 to endure heavy usage, the apparatus 10 is preferably constructed using sturdy materials, such as wood. More particularly, as illustrated in FIGS. 1-4, the apparatus 10 may be constructed using a frame comprised of a pair of opposed side members 18 joined by a rear member 20, a base member 21, a front member 23 and, optionally, one or more support members 22. Once constructed, the frame functions to carry the rubbing surface 14 which is preferably carried by the frame at an angle for exposing the rubbing surface 14 towards the user for the convenience of use by the user.

For storing one or more storyboards 12, which may be carried on wood, thick paper, cardboard, or the like, the apparatus 10 may be provided with a storyboard carrying well 24 which is sized to accommodate the storyboards 12. The storyboard carrying well 24 may be positioned proximate to the rear of the apparatus 10 where it is formed through the cooperation of the side members 18, the rear member 20, and, optionally, a support member 22. Once removed from the storyboard carrying well 24, a storyboard 12 may be carried on the apparatus 10 for display to the user by providing the apparatus 10 with a storyboard carrying easel 29. In the example apparatus 10 that is illustrated in the Figs., the easel 29 comprises a member mounted to a top panel 27 having a slot into which the bottom end of a storyboard 12 is inserted whereby the size of the member and arrangement of the slot functions to generally vertically orient and display the storyboard 12 to the user. It will be additionally appreciated that the storyboard carrying well 24 may be utilized to carry paper or other working materials that are to be used in connection with the rubbing process.

For storing the rubbing objects 16, which may be formed using blocks of wood, acrylic, or the like, the apparatus 10 may also be provided with a rubbing object carrying well 26 which is sized to accommodate the rubbing objects 16. The rubbing object carrying well 26 may be positioned proximate to and forward of the easel 29 to thereby allow a user to easily retrieve rubbing objects 16 from the object carrying well 26 even when a storyboard 12 is being carried by the easel 29. In the example apparatus 10 illustrated, the rubbing object carrying well 26 is attached to the rubbing surface 14 and is accessible via a slot 28 formed in the rubbing surface 14.

Once removed from the rubbing object carrying well 26, the user may arrange one or more of the rubbing objects 16 on the rubbing surface 14. In this regard, the user may select and arrange rubbing objects 16 in an attempt to duplicate an arrangement of objects, a story, etc. depicted on a storyboard 12, may select and arrange rubbing objects 16 in an attempt to provide a variation of an arrangement of objects, a story, etc. depicted on a storyboard 12, or the like. Similarly, and without limitation, the storyboard 16 may include images and/or text in one language while the rubbing objects depict similar images and/or text in another language whereby the apparatus 10 may be used for the purpose of providing to the user language education.

To facilitate the arrangement of the rubbing objects 16 on the rubbing surface 14, the rubbing surface 14 may further carrying a frame member 30 into which the rubbing objects 16 may be placed. Once the rubbing objects 16 are arranged as desired by a user in the frame member 30, a further frame member 32, which may be attached to the apparatus 10 by means of hinges 34, may be closed upon the frame member 30 to thereby capture the rubbing objects 16 upon the rubbing surface 14. In certain circumstances, the rubbing surface 14 may be provided with a tray like structure comprised of a plurality of compartments each sized and arranged to conveniently carry one of the rubbing objects 16.

In the instance where it is desired to create a rubbing of the rubbing objects 16, a piece of paper or other material may be positioned so as to overlay the rubbing objects 16 prior to the frame member 32 being closed upon the frame member 30. For the convenience of the user, rubbing materials, such as markers, crayons, or the like, may be provided and stored in a rubbing material carrier 25 which is carried by the rubbing surface member 14. In the example apparatus 10 illustrated in the Figs., a pair of rubbing material carriers 25 are provided and positioned adjacent to the sides of the rubbing object carrying frame. Still further storage for paper or the like may be provided by means of, for example, a drawer 38 which may be carried upon optional drawer rollers 40 attached to the bottom member 21 or which may be in the form of a cavity positioned behind a door. Yet further, the bottom member 21 may be associated with legs in order to elevate the apparatus 10, be associated with rollers to facilitate ease of movement of the apparatus 10, etc.

From the foregoing description it will be appreciated that the subject invention has the advantages of, among other things, providing: a hands-on dialogic reading tool for use in connection with educational purposes; a means for promoting literacy; a means for users to build a sense of story; a means for users to build a sense of sequence; a device that is easily portable and capable of fitting onto a table-top; a device that is constructed for long lasting value; a device that functions as a self-contained unit with the ability to store/carry all needed items; a device that encourages parent-child interaction; and a means for users to build or rehabilitate motor and cognitive skills. Furthermore, it will be appreciated by those skilled in the art that, while specific embodiments of the invention have been described in detail, various modifications and alternatives to those details could be developed in light of the overall teachings of this disclosure. Accordingly, the particular arrangements disclosed are meant to be illustrative only and not limiting as to the scope of the invention which is to be given the full breadth of the appended claims and any equivalents thereof.

What is claimed is:

1. An apparatus, comprising:
a frame carrying a rubbing board having a tray for receiving at least one rubbing object and carrying an easel for use in displaying to a user a storyboard.

2. The apparatus as recited in claim 1, wherein the rubbing board further includes a hinged cover for securing the at least one rubbing object within the tray.

3. The apparatus as recited in claim 1, wherein the frame includes a well for storing the storyboard.

4. The apparatus as recited in claim 1, wherein the frame includes a well for storing the one or more rubbing objects.

5. The apparatus as recited in claim 1, wherein the frame includes a well for storing rubbing materials.

6. The apparatus as recited in claim 2, wherein the easel comprises a member having a slot into which a bottom portion of the storyboard is placed and which is sized and arranged to hold the storyboard in a generally vertical orientation.

7. The apparatus as recited in claim 1, wherein the frame forms an interior which provides drawer space.

8. The apparatus as recited in claim 1, wherein the frame carries the rubbing board at an angle.

9. An apparatus, comprising:
a frame carrying a rubbing board having a tray for receiving at least one rubbing object and carrying an easel for use in displaying to a user a storyboard;
wherein the rubbing board further includes a hinged cover for securing the at least one rubbing object within the tray, the frame includes a well for storing the storyboard which is located in a position behind the easel, the frame includes a well for storing the one or more rubbing objects which is located in a position in front of the easel, and the frame includes a well for storing rubbing materials which is located in a position to a side of the tray.

10. The apparatus as recited in claim 9, wherein the easel comprises a member having a slot into which a bottom portion of the storyboard is placed and which is sized and arranged to hold the storyboard in a generally vertical orientation.

11. The apparatus as recited in claim 9, wherein the frame forms an interior which provides drawer space.

12. The apparatus as recited in claim 9, wherein the frame carries the rubbing board at an angle.
